(19) United States
(12) Patent Application Publication
(10) Pub. No.: US 2017/0042178 A1
(43) Pub. Date: Feb. 16, 2017

(54) SYSTEM, METHOD AND APPARATUS FOR MAKING FROZEN BEVERAGES

(71) Applicant: Hi Tec Metal Group, Inc., Cleveland, OH (US)

(72) Inventor: William J. Black, Orlando, FL (US)

(73) Assignee: HI TEC METAL GROUP, INC.

(21) Appl. No.: 15/233,274

(22) Filed: Aug. 10, 2016

Related U.S. Application Data
(60) Provisional application No. 62/205,227, filed on Aug. 14, 2015.

(51) Int. Cl. A23G 9/06; A23G 9/28; A23G 9/22; A23G 9/16

(52) U.S. Cl. CPC A23G 9/06; A23G 9/16; A23G 9/28; A23G 9/228

(57) ABSTRACT

Systems, apparatuses, and methods for making a frozen beverage are disclosed. In the systems, a mixing stage mixes water and syrup to form a mixture. An ingredient flow path upstream the mixing stage feeds the water and syrup to the mixing stage. The ingredient flow path includes at least one ingredient sensor and an adjustable liquid flow control device. A mixture flow path receives the mixture downstream the mixing stage and includes a mixture sensor. An electronic control system is in connected communication with the ingredient sensor, mixture sensor, and adjustable flow control device, stores a target value associated with a brix, and is configured to achieve the target value by adjusting liquid flow through the liquid flow control device based on flow detected by the ingredient and mixture sensors. A freezing stage downstream the mixture flow path at least partially freezes the mixture.

### CROSS-REFERENCE TO RELATED APPLICATIONS

This application claims priority to U.S. Provisional Patent Application Ser. No. 62/205,227, filed Aug. 14, 2015, the disclosure of which is hereby fully incorporated by reference in its entirety.

### BACKGROUND

The present disclosure relates generally to the field of beverage preparation and, more particularly, to preparation and dispensing of frozen beverages and equipment therefor.

Frozen carbonated beverages (“FCBs”) are popular drink products that contain a mixture of water, flavored syrup, and carbon dioxide (“CO₂”). A slush beverage is produced from the partial freezing of a combination of the carbonated water and syrup.

FCBs are made by special beverage dispensing equipment that combines and mixes the ingredients together. Generally, water is carbonated and subsequently blended with the flavored syrup in a mixing chamber. The water and syrup mixture has a specific water to syrup ratio. The water to syrup ratio is referred to as the “brix”. The water and syrup mixture is then fed into a chilling chamber where it is partially frozen and maintained in this partially frozen state before being dispensed. The chilling chamber is typically a refrigerated cylinder. Typically, an auger or a blade in the chilling chamber agitates the mixture to maintain its consistency. An FCB confection is made by continual harvesting of the combination of carbonated water and syrup from the interior perimeter of the refrigerated cylinder or chamber.

The brix of the product affects the flavor and sweetness of the beverage and is, therefore, an important parameter to control. In certain conventional FCB equipment, the brix is controlled by manually adjusting the syrup flow rate using a sleeve placed over the tube through which the syrup is supplied to the mixing chamber. As this sleeve is manually adjusted, it mechanically alters the flow rate of the syrup to change the brix. This manual technique is a cumbersome and inexact method for controlling the brix.

Besides the brix, another important parameter to control is called “overrun”. Overrun is a variable associated with the relative amounts of carbon dioxide and liquid in the frozen beverage. It is typically expressed as a percentage and is calculated as

$$\frac{Unfrozen Weight - Frozen Weight}{Frozen Weight} \times 100 \% .$$

A beverage with 100% overrun has equal volumes of CO₂ and liquid. Controlling the overrun is important because different FCB sellers and markets often have different overrun requirements for their beverages.

Overrun varies based on a number of factors, including the pressure of the carbon dioxide and atmospheric conditions in the environment of the equipment. In conventional FCB equipment, the overrun is determined and impacted by the pressure of carbon dioxide in the blender. The pressure is manually adjusted from a valve on a CO₂ supply tank until the desired overrun is achieved. Unfortunately, however, the pressure and the associated overrun do not remain constant during cycles of use due to many factors, including temperature fluctuations. Manual control of the overrun is, therefore also a cumbersome and inexact process.

In view of the foregoing, it would be advantageous to be able to make frozen beverages, including FCBs, using equipment that provides for dynamic and automatic brix control and carbonation control.

### BRIEF DESCRIPTION

The present disclosure presents frozen carbonated beverage (“FCB”) systems, methods, and apparatuses which meet these needs. Disclosed in various embodiments herein are systems, apparatuses, and methods for making frozen beverages having a desired brix and desired carbon dioxide content. The embodiments disclosed herein permit dynamic and automatic control of the brix and carbon dioxide to improve the production of FCBs.

Disclosed herein are frozen beverage making systems comprising: an ingredient flow path that feeds water and syrup to a mixing stage that mixes the water and syrup to form a mixture, the ingredient flow path including (i) at least one ingredient sensor positioned along either a water or syrup flow path that detects a property of the water or syrup and (ii) at least one adjustable liquid flow control device that adjusts liquid flow through the ingredient flow path; a mixture flow path that receives the mixture downstream the mixing stage, the mixture flow path including a mixture sensor that detects a property of the mixture; at least one carbon dioxide flow path that feeds carbon dioxide to the frozen beverage making system, the at least one carbon dioxide flow path including an adjustable gas pressure controller that detects and regulates the carbon dioxide gas pressure of the system; an electronic control system: (i) in connected communication with the at least one ingredient sensor, mixture sensor, at least one adjustable flow control device, and the adjustable gas pressure controller; (ii) storing target values associated with a brix and a carbonation pressure and; (iii) configured to achieve the target values by adjusting liquid flow through the at least one liquid flow control device based on the property detected by the ingredient and mixture sensors and by adjusting carbonation pressure through the at least one adjustable gas pressure controller; and a freezing stage downstream the mixing stage.

In some embodiments, the frozen beverage making systems of the present disclosure include a carbonator upstream the mixing stage that receives and carbonates the water in the ingredient flow path from the at least one carbon dioxide flow path. A blender can also be included upstream the freezing stage that receives and carbonates the mixture in the mixture flow path from the at least one carbon dioxide flow path. The blender can carbonate the mixture from a second carbon dioxide flow path including an adjustable gas pressure controller that detects and regulates the carbon dioxide gas pressure of the blender. Alternatively, the at least one carbon dioxide flow path can feed carbon dioxide to the freezing stage downstream the mixing stage.

In further embodiments of the frozen beverage making systems disclosed herein, the at least one ingredient sensor is a flowmeter that detects and measures a flow rate of the water or syrup. The mixture sensor is a flowmeter that detects and measures a flow rate of the mixture. The electronic control system achieves the target value associated with the brix based on the flow rates detected by the at least ingredient sensor and the mixture sensor.

In additional embodiments of the exemplary frozen beverage making systems, the at least one ingredient sensor is a refractive sensor that detects and measures a sugar content of the syrup. The mixture sensor is a refractive sensor that detects and measures a sugar content of the mixture. The electronic control system achieves the target value associated with the brix based on the sugar content detected by the mixture sensor.

Also disclosed herein are methods for making a frozen beverage comprising (a) receiving a first signal from an ingredient sensor positioned along either a water or syrup conduit of an ingredient flow path that feeds water and syrup to a mixing stage where the water and syrup are mixed; (b) receiving a second signal from a mixture sensor positioned along a mixture flow path that receives the mixture from the mixing stage, the first and second signal being associated with a brix; (c) receiving a signal from a gas pressure controller positioned along a carbon dioxide flow path that feeds carbon dioxide to the ingredient flow path or the mixture flow path, the signal being associated with gas pressure at the ingredient flow path or the mixture flow path; (d) adjusting liquid flow through a liquid flow control device positioned along either the water or syrup flow path until a target value associated with the brix is achieved; (e) adjusting the gas pressure with the gas pressure controller until a target value associated with a desired carbonating pressure is achieved; and (f) at least partially freezing the mixture downstream the mixture flow path.

Embodiments of the exemplary method for making a frozen beverage disclosed herein may further comprise injecting carbon dioxide from the carbon dioxide flow path upstream the mixing stage at the water conduit of the ingredient flow path, downstream the mixing stage at the mixture flow path, or both.

Monitoring a sugar content of the mixture with the mixture sensor to generate the second signal and wherein the target value associated with the brix is a target sugar content of the mixture may also be included in some embodiments. Alternatively, embodiments of the exemplary method may include monitoring a flow rate in either the water or syrup conduit with the ingredient sensor to generate the first signal and monitoring a flow rate in the mixture flow path with the mixture sensor to generate the second signal, wherein the target value associated with the brix is a target water or syrup flow rate and a target mixture flow rate.

Frozen beverage making apparatuses are also disclosed herein, comprising: a water conduit and a syrup conduit that feed water and syrup to a mixing stage that forms a mixture, the water conduit having a water flow valve for regulating water flow through the water conduit and the syrup conduit having a syrup flow valve for regulating syrup flow though the syrup conduit; a carbon dioxide conduit having a gas pressure controller for feeding carbon dioxide to the frozen beverage making apparatus, the gas pressure controller including a pressure sensor for regulating carbonation pressure in the system; an ingredient sensor positioned along at least one of the water conduit or the syrup conduit for measuring a property of the water or syrup; a mixture conduit that receives the mixture and includes a mixture sensor for measuring a property of the mixture; at least one of: (i) a carbonator that receives and carbonates the water in the water conduit from the carbon dioxide conduit and (ii) a blender that receives and carbonates the mixture in the mixture conduit from the carbon dioxide conduit; an electronic control system: (i) in connected communication with the ingredient sensor, the water flow valve, the syrup flow valve, and the gas pressure controller; (ii) storing target values associated with a brix and a carbonation pressure and; (iii) configured to achieve the target values by adjusting at least one of water flow through the water flow valve or syrup flow through the syrup flow valve, based on the property detected by the ingredient and mixture sensors, and by adjusting carbonation pressure through the gas pressure controller; and a freezing stage that receives and at least partially freezes the mixture.

In some embodiments of the exemplary apparatus the ingredient sensor and the mixture sensor is a flowmeter that detects and measures a flow rate of the water or syrup and the flow rate of the mixture. In other embodiments, the ingredient sensor and the mixture sensor is a refractive sensor that detects and measures sugar content of the syrup and sugar content of the mixture.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front perspective view of a frozen beverage apparatus.

FIG. 2 is a block diagram of a brix control system.

FIG. 3 is a flowchart illustrating a brix control method.

FIG. 4 is a block diagram of a carbonation control system.

FIG. 5 is a flowchart illustrating a carbonation control method.

FIG. 6 is a block diagram of a frozen carbonated beverage system with brix control and carbonation control.

FIG. 7 is a block diagram of another frozen carbonated beverage system including flow sensing, a carbonator for providing carbon dioxide to the system, and a blender.

FIG. 8 is a block diagram of an additional frozen carbonated beverage system including a carbonator, refractive sensors, and a blender.

FIG. 9 is a block diagram of a further frozen carbonated beverage system including flow sensors and in-barrel carbonation.

FIG. 10 is a block diagram of a frozen carbonated beverage system including refractive sensors and in-barrel carbonation.

FIG. 11 is a block diagram illustrating additional details of the control system for a frozen carbonated beverage system according to embodiments of the present disclosure.

FIG. 12 is a block diagram of control circuitry connections for the control system of FIG. 11.

FIG. 13 is a block diagram illustrating portions of the control system memory for the control system of FIG. 11 according to one embodiment.

FIG. 14 is a flowchart illustrating a second brix control method.

FIG. 15 is a flowchart illustrating a second carbonation control method.

FIG. 16 is a block diagram illustrating portions of the control system memory for the control system of FIG. 11 according to another embodiment.

FIG. 17 is a flowchart illustrating a third brix control method

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function. Furthermore, it should be understood that the drawings are not to scale.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of from 2 grams to 10 grams” is inclusive of the endpoints, 2 grams and 10 grams, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range from 2 to 4.” More specifically, the term “about” may refer to plus or minus 10% of the indicated number.

The present disclosure refers to components which are “upstream” and “downstream” of other components. These two terms are relative to another named component. A given component is “upstream” of a named component if a flow path runs through the given component before running through the named component. Similarly, a given component is “downstream” of a named component if a flow path runs through the given component after running through the named component.

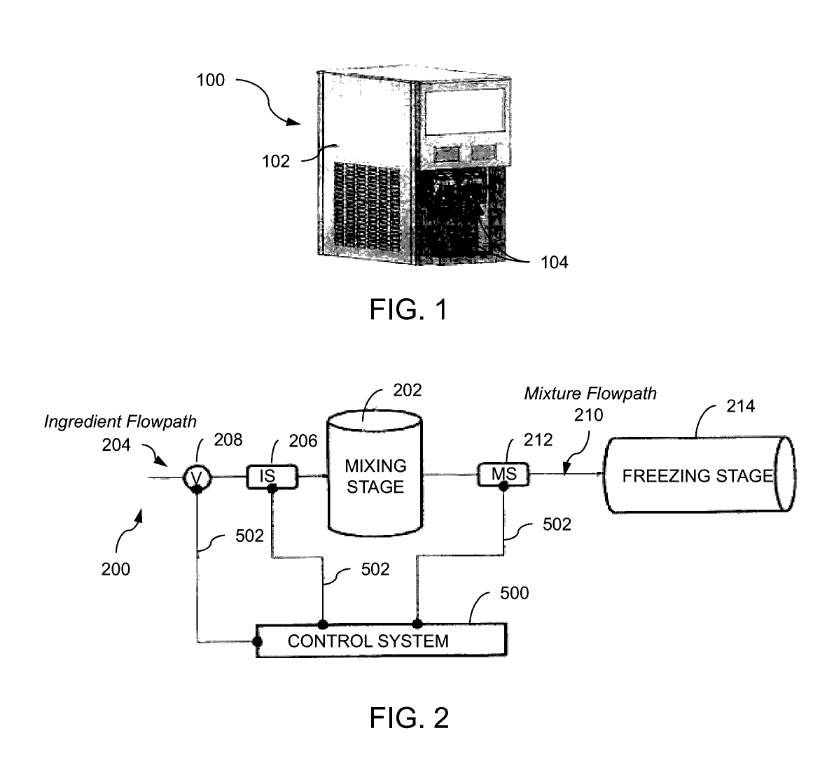

Referring to FIG. 1, a frozen beverage apparatus 100 includes a housing 102 containing components for making frozen beverages, such as frozen carbonated beverages (FCBs). The components provide controls and equipment for preparing frozen beverages having a desired brix and/or desired carbonation level or overrun. Once prepared, the frozen beverage is dispensed from a dispenser 104. The two-dispenser example shown in FIG. 1, is equipped to prepare two flavors of frozen beverages and dispense them separately. Other examples may have more or fewer dispensers for more or fewer flavors. The machines can be described by the number of dispensers such as a two barrel or four barrel machine.

The desired brix is achieved using a brix control system 200, such as the example in FIG. 2. The brix control system 200 includes a mixing stage 202 that mixes water and syrup to form a mixture of water and syrup. An ingredient flow path 204 upstream of the mixing stage 202 feeds the water and syrup to the mixing stage 202. The ingredient flow path 204 includes at least one ingredient sensor 206 that aids in determining the brix of the water and syrup mixture and at least one adjustable liquid flow control device 208, such as a valve, that adjusts water or syrup flow.

The ingredient sensor 206 may be a flowmeter adapted to detect and measure at least one of syrup flow or water flow, depending on whether it is positioned along a water flow path or syrup flow path. In other embodiments, another flowmeter may be employed so that both water flow and syrup flow are measured separately. In some embodiments, the ingredient sensor 206 may be a refractive sensor adapted to detect and measure the sugar content of the syrup flow.

A mixture flow path 210 receives the water and syrup mixture downstream of or after an outlet of the mixing stage 202. The mixture flow path 210 includes a mixture sensor 212 that aids in determining the brix of the mixture. In some embodiments, the mixture sensor 212 may be a flowmeter adapted to detect and measure the mixture flow. In other embodiments, the mixture sensor 212 may be a refractive sensor adapted to detect and measure the sugar content of the mixture. A freezing stage 214 is positioned downstream the mixture flow path for receiving and at least partially freezing the mixture.

An electronic control system 500 is in connected communication with the ingredient sensor 206, mixture sensor 212, and adjustable flow control device 208 via control lines 502, such as wiring or the like. The control system 500 stores a desired target value associated with the brix and is configured to achieve the target value by adjusting liquid flow through the liquid flow control device 208. In some embodiments where the ingredient and mixture sensors 206, 212 are flowmeters, liquid flow is adjusted based on flow detected by the ingredient sensor 206 and mixture sensor 212 and by executing program instructions stored on the control system 500 for automatic operation of the liquid flow control device. In other embodiments, where the ingredient and mixture sensors 206, 212 are refractive sensors, liquid flow is adjusted based on sugar content detected by the ingredient sensor and mixture sensor and by executing program instructions stored on the control system 500 for automatic operation of the liquid flow control device.

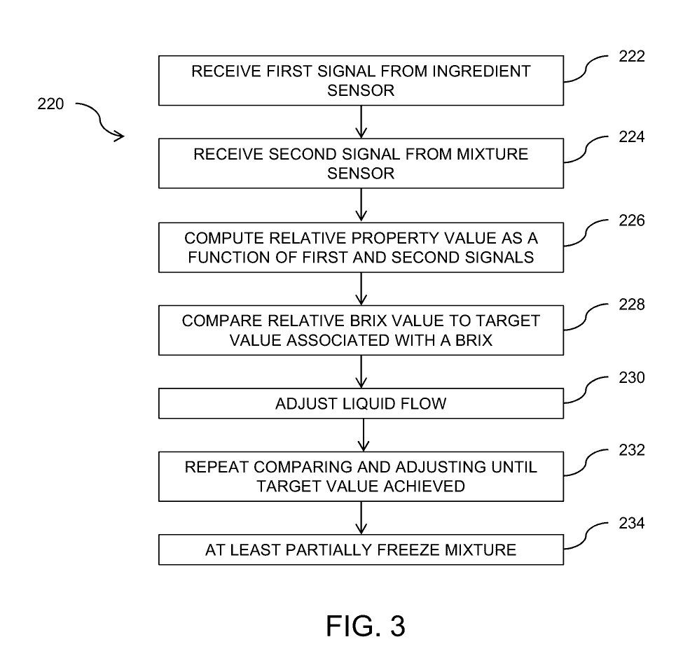

Referring now to FIG. 3, the brix control system 200 may be used to execute a method 220 for making a frozen beverage having a desired brix. The method includes receiving a first signal from the ingredient sensor (block 222) positioned along at least one of the water or syrup flow path of the ingredient flow path and receiving the second signal from the mixture sensor positioned downstream of the mixing stage along the mixture flow path (block 224).

At block 226, a relative property value of at least one of the water or syrup and the mixture is computed as a function of the first and second signals and at block 228 the relative property value is compared to a target value associated with the desired brix. At block 230, liquid flow is adjusted using the adjustable liquid flow control device. The comparing and adjusting steps are repeated until the target value is achieved (block 232). The mixture is subsequently chilled to achieve at least partial freezing of the mixture. This method 220 may be executed by the control system 500 as a set of program instructions.

The desired brix may vary by product, flavor, or market. As such, the ability to program and control desired brix for a variety of products, flavors, and markets is advantageous. The brix control system 200 system may also provide a more consistent product with respect to flavor, sweetness and texture.

The target value associated with the desired brix may be programmed into the control system 500 as a preset value. In embodiments where the ingredient sensor 206 is a flowmeter, the flowmeter may be positioned along a water conduit or a syrup conduit of the ingredient flow path 204. In such embodiments, the first signal from the ingredient sensor is a flow rate of the water or syrup, and the second signal from the mixture sensor is a flow rate of the mixture, with both the first and second signals being associated with the brix. In embodiments where the ingredient sensor 206 is a refractive sensor, the refractive sensor can be positioned along a syrup conduit of the ingredient flow path 204. In such embodiments, the first signal from the ingredient sensor is a sugar content of the syrup, and the second signal from the mixture sensor is a sugar content of the mixture, with both the first and second signals being associated with the brix.

The control system 500 receives a value associated with the brix, which can be the water or syrup flow rate or sugar content detected by the ingredient sensor 206, depending on whether a flowmeter or a refractive sensor is used. The control system 500 also receives another value associated with the brix, which can be the mixture flow rate or the mixture sugar content detected by the mixture sensor 212, depending on whether a flowmeter or a refractive sensor is used. The control system 500 uses the values to estimate relative amounts of water and syrup in the mixture.

For example, if the ingredient sensor 206 is a flowmeter located on the water conduit, it detects a value associated with the flow rate of water to the mixing stage 202. The mixture sensor 212 detects a value associated with a flow rate of the mixture. From these two values, the control system 500 estimates the flow rate of syrup and determines the relative amounts of water and syrup in the mixture, which is associated with a brix.

If, on the other hand, the ingredient sensor 206 is a flowmeter located on the syrup conduit, it instead detects a value associated with the flow rate of syrup to the mixing stage 202, but still allows the relative amounts of water and syrup in the mixture to be determined.

As another example, if the ingredient sensor 206 is a refractive sensor located on the syrup conduit, it detects a sugar content of the sugar flow to the mixing stage 202. The mixture sensor 212 measures a sugar content associated with the mixture of syrup and water. From these two values, the control system 500 determines the relative amounts of water and syrup in the mixture, which is associated with a brix.

When flowmeters are used for the ingredient and mixture sensors 206, 212, the flowmeters are adapted to measure liquid flow such as a flow rate. The flow rate may be reported as a mass flow rate (mass/time), such as ounces per second. An example of a suitable commercial flowmeter is GEMS FT-210 liquid flowmeter.

When refractive sensors are used for the ingredient and mixture sensors 206, 212, the refractive sensors are adapted to measure the index of refraction of the syrup and the mixture. The index of refraction corresponds to the sugar content of the syrup and mixture and, therefore, provides a measurement directly associated with the brix. The sugar content may be reported as a percentage. An example of suitable commercial refractive sensors include electro-optical devices which utilize surface plasmon resonance (SPR) to detect small changes in the refractive index of liquids, such as the Spreeta® sensor available from Sensata Technologies, Inc.

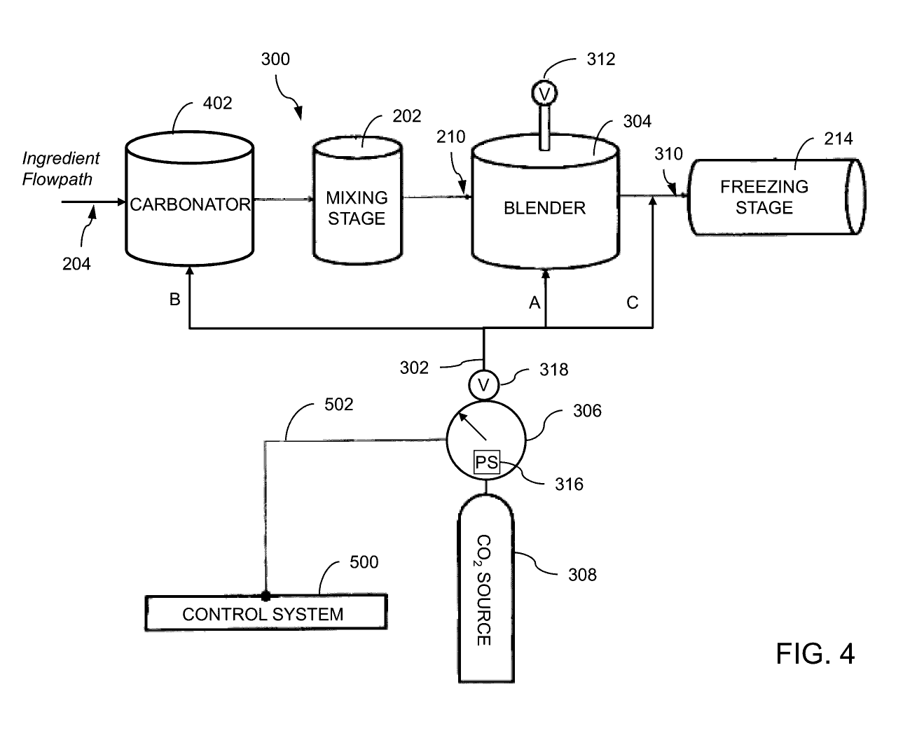

The desired carbonation for the beverage is achieved using a carbonation control system 300 such as the example in FIG. 4. In the carbonation control system 300, the ingredient flow path 204 feeds water and syrup to the mixing stage 202. A carbon dioxide flow path 302 feeds carbon dioxide gas to at least one injection location A, B, and C. An adjustable gas pressure controller 306 is positioned along the carbon dioxide flow path 302 and includes a pressure detector 316 and a gas flow control device 318 for detecting and regulating the gas pressure in the carbonation control system. Carbon dioxide is supplied to the carbon dioxide flow path 302 from a carbon dioxide source 308, such as a compressed gas tank, for example.

Injection location A feeds carbon dioxide gas to a blender 304 downstream of the mixing stage 202. The blender 304 receives the mixture from the mixing stage and carbonates the mixture. The gas pressure controller 306 and associated pressure detector 316 and gas flow control device 318 detect and regulate the gas pressure in the blender 304. The freezing stage 214, is downstream of the blender 304 for receiving and at least partially freezing the carbonated mixture.

Injection location B feeds carbon dioxide gas to a carbonator 402 upstream of the mixing stage 202. The carbonator receives water from the water source (FIG. 2) and carbonates the water. The gas pressure controller 306 and associated pressure detector 316 and gas flow control device 318 detect and regulate the gas pressure in the carbonator 402. The mixing stage 202 is downstream of the carbonator 402 for receiving and mixing the carbonated water from the carbonator with the syrup from the syrup source (FIG. 2). The freezing stage is downstream of the carbonator 402 and mixing stage 202 for receiving and at least partially freezing the carbonated mixture.

Injection location C feeds carbon dioxide gas in the barrel of the freezing stage 214 downstream of the mixing stage 202. The freezing stage 214 receives the mixture from the mixing stage and carbonates the mixture. The gas pressure controller 306 and associated pressure detector 316 and gas flow control device 318 detect and regulate the gas pressure at the freezing stage 214.

The carbonation control system 300 can be adapted to provide carbon dioxide gas at any one of injection locations A, B, and C or a combination of injection locations A, B, and C depending on the needs of the user. However, it is noted that primary carbonation generally takes place at one of injection locations A, B, or C, with additional carbonation provided at an injection location different from the location of primary carbonation if desired. For example, carbonation can primarily occur in the carbonator 402 at injection location B, with additional carbonation provided for in the blender 304 at injection location A. It should be understood from the present disclosure that if only one of the injection locations A, B, or C is desired, then carbonation at the other injection locations can be excluded from the carbonation control system 300. In such a case, the components associated with the excluded injection location(s) would also be excluded from the carbonation control system 300.

Although FIG. 4 illustrates only one gas pressure controller 306 and associated carbon dioxide source 308, pressure detector 316, and gas flow control device 318, it should be understood that more than one controller and associated carbon dioxide source, pressure detector, and gas flow control device can be included depending on the number of injection locations desired (i.e., one of each for each injection location). Alternatively, gas pressure controller 306 and associated carbon dioxide source 308, pressure detector 316, and gas flow control device 318 can be used to regulate all desired injection locations.

The carbonation control system 300 is adjustable to provide different desired overruns for different products or markets. For example, the carbonation control system 300 can provide a first product with an overrun of 15% and be adjusted to later provide a different overrun of 100%. An example overrun measurement includes an unfrozen weight of 16 ounces for the syrup and water mixture and a corresponding frozen weight of 8 ounces, resulting in a 100% overrun. A second example overrun measurement includes an unfrozen weight of 16 ounces for the syrup and water mixture and a corresponding frozen weight of 8.5 ounces, resulting in an 88% overrun. This adjustability is advantageous over conventional systems with manual carbonation control.

The control system 500 stores a target value associated with the desired carbonating pressure. The control system 500 receives a signal via the control lines 502 from the gas pressure controller 306 (or controllers). The signal includes a value associated the gas pressure in the carbonation control system, such as at the blender 304, carbonator 402, or freezing stage 214 depending on the desired injection locations A, B, or C being utilized. The control system 500 is configured to achieve the target value associated with the desired carbonating pressure by electronically adjusting the gas pressure using the adjustable gas pressure controller 306 (or controllers) by executing program instructions stored on the control system 500.

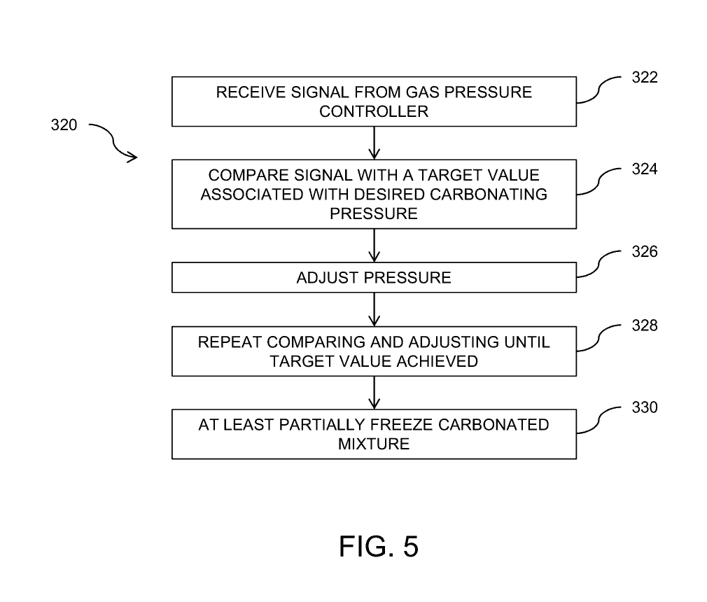

Referring now to FIG. 5, the carbonation control system 300 may be used to execute a method 320 for making a frozen beverage having a desired carbon dioxide content. At block 322, the method includes receiving the signal from the gas pressure controller. At block 324, the signal is compared to the target value associated with the desired carbonating pressure. The target value may be stored on the control system 500 as a preset value. At block 326 the control system 500 adjusts the pressure in the system using the gas pressure controller at one or more of the blender 304, carbonator 402, and freezing stage 214 depending on the desired injection locations being utilized. The steps at blocks 324 and 326 are repeated until the target value is achieved (block 328). At block 330, the carbonated mixture is chilled to at least partially freeze the mixture. This method 320 may be executed by the control system 500 as a set of program instructions.

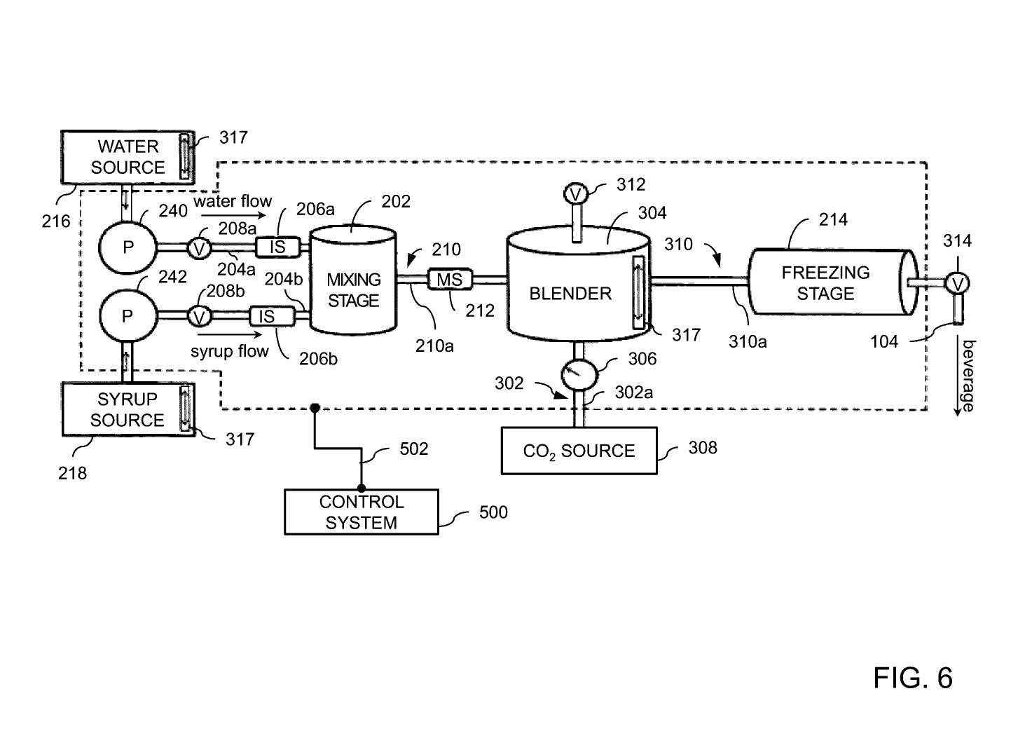

In some embodiments of the apparatus 100 the brix control system 200 is combined with the carbonation control system 300 so that the apparatus can prepare frozen carbonated beverages with the desired brix and carbonation. Examples of such embodiments will now be described with reference to FIGS. 6-10.

With reference to FIG. 6, water is provided to the apparatus 100 from a water source 216 such as a conventional water source, including, for example, water from a water line, tap, or tank. Syrup is supplied to the apparatus 100 from a syrup source such as a conventional syrup source used in beverage preparation, including, for example, syrup from a container, a bag in a box container, or a tank. Water and syrup are drawn into, respectively, a water conduit 204a and a syrup conduit 204a by activating a water pump 240 and a syrup pump 242.

A liquid flow control device 208a, which can be in the form of a water flow valve, is positioned along the water conduit 204a for regulating water flow through the water conduit 204a. Downstream of the liquid flow control device 208a is a first ingredient sensor 206a, which is a flowmeter that detects water flow through the water conduit 204a to the mixing stage 202. Another liquid flow control device 208b, which can be in the form of a syrup flow valve, is positioned along the syrup conduit 204b for regulating syrup flow through the syrup conduit 204b. Downstream of the liquid flow control device 208b is a second ingredient sensor 206b, which is a flowmeter that detects syrup flow through the syrup conduit 204b. Sensors 206a, 206b and 212 can be provided, for example, as GEMS FT-210 sensors, although other sensors can be utilized in other examples. It should be understood from the present disclosure that either the first ingredient sensor 206a or the second ingredient sensor 206b can be used depending on whether the brix value computed by the control system 500 is based on the flow rate of water or the flow rate of syrup relative to the flow rate of the mixture.

The valves 208a, 208b are incrementally adjustable so that the flow rate through each can be changed as needed. The flow rates may vary depending on the desired brix. For example, a desired water flow rate may be about 3.2 oz./sec. and a desired mixture flow rate may be about 0.7 oz./sec. to yield a water/syrup ratio of about 4.5:1. An example of a desired brix is about 13.5±0.5. The ratio is adjustable to a wide range, but in some examples a ratio below 5:1 may lead to complete freezing because the lower sugar content leads to a lower beverage freezing point. If desired, water flow may, for example, be somewhere between about 3 oz./sec. and about 4 oz./sec. ounces per second in some applications. The water flow rate may affect the carbonation level.

An example of a commercial valve that is suitable is a proportional solenoid valve such as a DELTOL DPV1N valve.

Water and syrup are fed to the mixing stage 202 by the water and syrup conduits 204a, 204b at a flow rate that is determined by the water flow valve 208a and syrup flow valve 208b, respectively. The mixing stage 202 mixes the water and syrup to form the mixture.

The mixing stage 202 may take different forms, depending on what is desired and the volumes being mixed. In certain cases, for example, the mixing stage 202 may be a section of a conduit in which the water and syrup come together. In other cases, the mixing stage 202 may be a container. To assist with mixing, the mixing stage 202 may include a mixing device such as a paddle, auger, beater, or the like.

The mixture flows from the mixing stage 202 through the mixture flow path 210, which is in the form of a mixture conduit 210a. The mixture sensor 212 is positioned along the mixture conduit 210a and detects the flow of mixture though the mixture conduit 210a.

The blender 304 receives the mixture downstream the mixture sensor 212. Carbon dioxide from the carbon dioxide source 308 is fed to the blender 304 through the carbon dioxide flow path 302 in the form of a carbon dioxide conduit 302a. The carbon dioxide conduit 302a is made to withstand high pressure. The blender 304 includes a pressurizable vessel that is also made to withstand high pressure.

The gas pressure controller 306 is positioned along the carbon dioxide conduit 302a. It measures gas pressure at the blender 304 and is adjustable so that it can vary the gas pressure, depending on the desired carbonation level for the beverage being prepared. A pressure relief valve 312 will purge excess pressure from the blender 304.

The gas pressure controller 306 is incrementally adjustable so that the gas pressure can be changed as needed. An example of a suitable commercial gas pressure controller is a PARKER 415 regulator.

Carbonated mixture flows from the blender 304 through the carbonated mixture flow path 310, which is in the form of a carbonated mixture conduit 310a.

The freezing stage 214 receives the carbonated mixture from the carbonated mixture conduit 310a and at least partially freezes the carbonated mixture. The freezing stage 214 includes a refrigerated cylinder or container and an agitator such as a mixer, paddle, blade, beater, or the like. The agitator agitates the carbonated mixture so that it will maintain a consistent texture and will remain only semi-frozen so that the carbonated mixture will flow. If desired, torque on the agitator may be used as a measurement of the viscosity of the carbonated mixture to ensure the desired flowability.

The prepared frozen carbonated beverage may be dispensed from the freezing stage 214 by opening a dispensing nozzle 314, which allows the beverage to flow out of the dispenser 104.

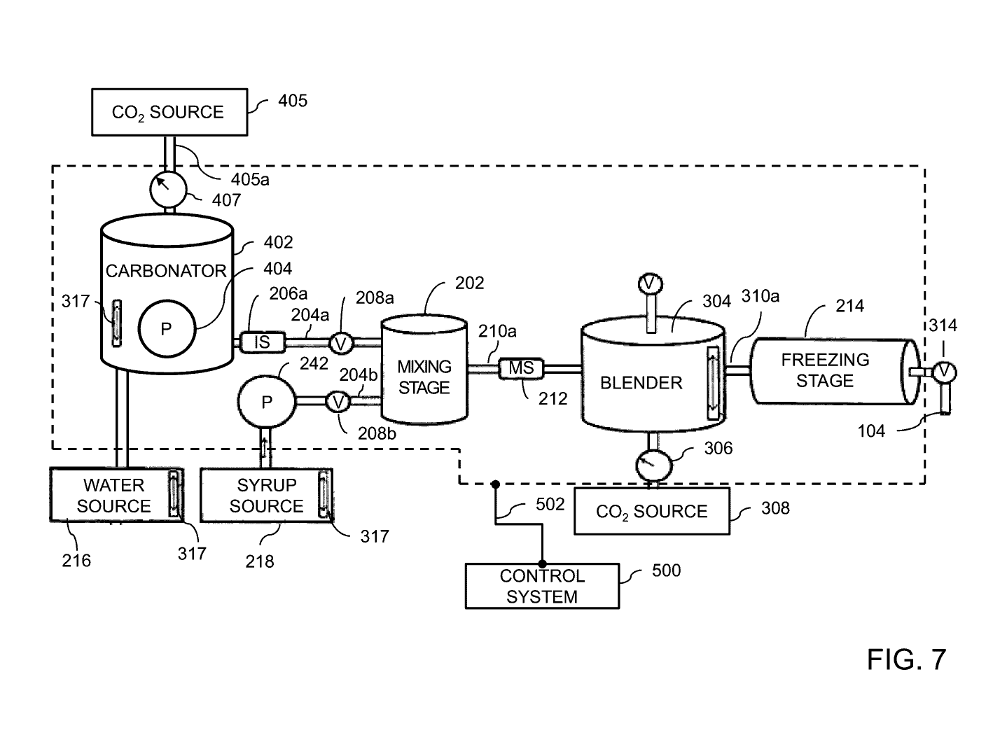

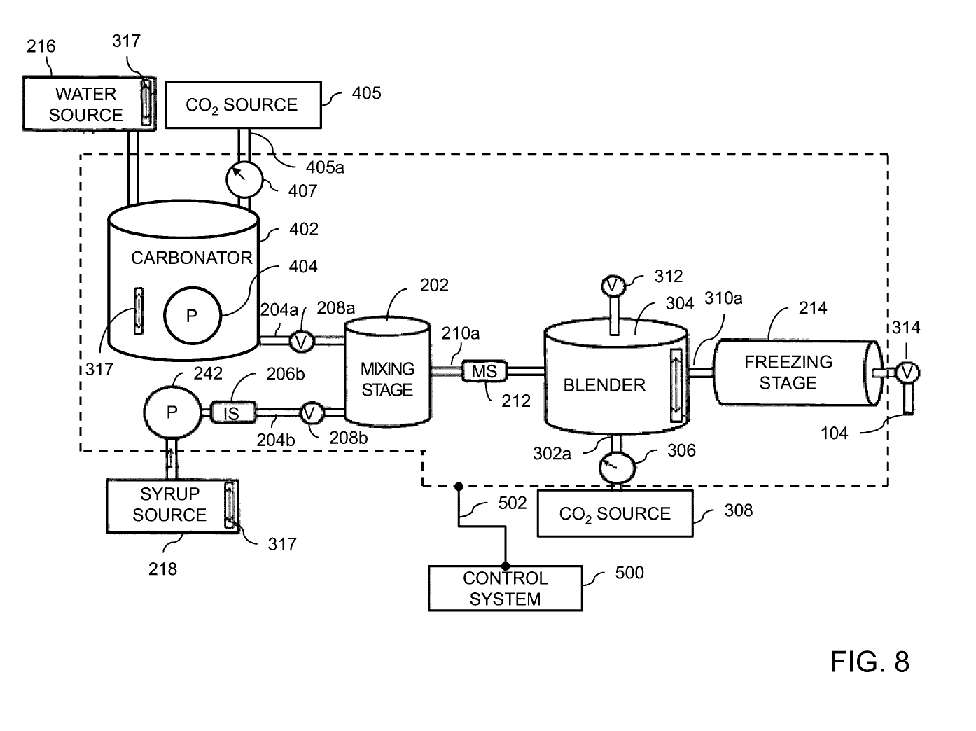

Referring now to FIG. 7 and FIG. 8, further embodiments are illustrated in which the brix control system 200 is combined with the carbonation control system 300 so that the apparatus 100 can prepare frozen carbonated beverages with the desired brix and carbonation.

Water is provided to the apparatus 100 from a water source 216 and syrup is supplied to the apparatus 100 from a syrup source 218. Water and syrup are drawn into, respectively, a water conduit 204a and a syrup conduit 204a by activating a water pump 404 and a syrup pump 242.

The embodiments illustrated in FIGS. 7-8 differ from the embodiment of FIG. 6 by changing the location where carbonation primarily occurs. In this regard, a carbonator 402 is included downstream of water source 216 and includes a water pump 404 for drawing water into the carbonator and subsequently into the water conduit 204a. Carbon dioxide from the carbon dioxide source 405, which can be the same or a different source from the carbon dioxide source 308, is fed to the carbonator 402 via carbon dioxide conduit 405a. Carbon dioxide from source 405 is fed to the carbonator 402 in substantially the same manner as the carbon dioxide fed to the blender 304. Accordingly, a gas pressure controller 407 and pressure relief valve (not shown) maintain the appropriate pressure and carbonation levels in the carbonator. Alternatively, gas pressure controller 306 can also be used for both the carbonator 402 and the blender 304. The carbonator 402 includes a pressurizable tank or vessel that is made to withstand high pressure. Carbonated water flows from the carbonator 402 through the water conduit 204a. The carbonator 402 can also include a liquid level sensor 317 for communicating liquid level values to the control system 500.

With reference to FIG. 7, the frozen carbonated beverage system includes at least one ingredient sensor 206a. Here, the ingredient sensor 206a is a flowmeter that detects carbonated water flow from the carbonator 402 through the water conduit 204a to the mixing stage 202. Downstream of the ingredient sensor 206a is the liquid flow control device 208a, which can be in the form of a water flow valve. The water valve 208a is positioned along the water conduit 204a for regulating water flow through the water conduit. Although the valve 208a is illustrated in FIG. 7 as being located downstream of the ingredient sensor 206a, the valve could also be positioned upstream of the first ingredient sensor. Another liquid flow control device 208b, which can be in the form of a syrup flow valve, is positioned along the syrup conduit 204b for regulating syrup flow through the syrup conduit 204b.

The valves 208a, 208b are incrementally adjustable so that the flow rate through each can be changed to achieve the desired brix based on the water and syrup flow rates. Examples of a desired brix or water/syrup ratio includes about 4.5:1 to about 13.5±0.5. The ratio is adjustable to a wide range, but in some examples a ratio below 5:1 may lead to complete freezing because the lower sugar content leads to a lower beverage freezing point.

Water and syrup are fed to the mixing stage 202 by the water and syrup conduits 204a, 204b at a flow rate that is determined by the water flow valve 208a and syrup flow valve 208b, respectively. The mixing stage 202 mixes the carbonated water and syrup to form the carbonated mixture. The mixing stage 202 may be a section of a conduit in which the water and syrup come together. In other cases, the mixing stage 202 may be a container. To assist with mixing, the mixing stage 202 may include a mixing device such as a paddle, auger, beater, or the like. The carbonated mixture flows from the mixing stage 202 through the mixture conduit 210a to the mixture sensor 212, which is positioned along the mixture conduit and detects the flow of carbonated mixture though the mixture conduit 210a.

A blender 304 optionally receives the carbonated mixture downstream the mixture sensor 212. If necessary, additional carbon dioxide from the carbon dioxide source 308 can be fed to the blender 304 with the gas pressure controller 306, as described above with respect to FIG. 6. Carbonated mixture flows from the blender 304 through the carbonated mixture conduit 310a.

The freezing stage 214 receives the carbonated mixture from the carbonated mixture conduit 310a and at least partially freezes the carbonated mixture. The prepared frozen carbonated beverage may be dispensed from the freezing stage 214 by opening a dispensing nozzle 314, which allows the beverage to flow out of the dispenser 104.

The embodiment illustrated in FIG. 7 requires only one ingredient sensor 206a because the brix value computed by the control system 500 is based on the flow rate of water relative to the flow rate of the mixture.

The embodiment illustrated in FIG. 8 is substantially similar to the embodiment illustrated in FIG. 7, including the carbonator 402 and associated pump 404. However, the embodiment of FIG. 8 relies on refractive sensors for the ingredient sensor 206b and mixture sensor 212 as opposed to flowmeters. As shown in FIG. 8, at least one ingredient sensor 206b is included. The ingredient sensor 206b is a refractive sensor that detects sugar content of the syrup in the syrup conduit 204b. Downstream of the ingredient sensor 206b is the liquid flow control device 208b, which can be in the form of a syrup flow valve. The syrup valve 208b is positioned along the syrup conduit 204b for regulating syrup flow through the syrup conduit. Although the valve 208b is illustrated in FIG. 8 as being located downstream of the ingredient sensor 206b, it should be understood from the present disclosure that the valve could also be positioned upstream of the ingredient sensor.

The valves 208a, 208b are incrementally adjustable so that the flow rate through each can be changed to achieve the desired brix based on the syrup content of the mixture. Examples of a desired brix or water/syrup ratio includes about 4.5:1 to about 13.5±0.5. The ratio is adjustable to a wide range, but in some examples a ratio below 5:1 may lead to complete freezing because the lower sugar content leads to a lower beverage freezing point.

The carbonated mixture flows from the mixing stage 202 through the mixture conduit 210a to the mixture sensor 212, which detects the sugar content of the carbonated mixture in mixture conduit 210a. Liquid flow is adjusted based on sugar content detected by the ingredient sensor 206b and mixture sensor 212 and by executing program instructions stored on the control system 500 for automatic operation of the liquid flow control devices 208a and 208b.

The ingredient sensor 206b and the mixture sensor 212 in FIG. 8 are refractive sensors or refractometers which measure the index of refraction of the syrup or the carbonated mixture, respectively. The index of refraction corresponds to the sugar content of the syrup or mixture and, therefore, provides a measurement directly associated with the brix. The brix of a sugar syrup is typically about 60 and the brix of a diet syrup is typically about 10. A typical desired brix for an FCB using sugar syrups is about 13.5. The refractive sensor 206b may be used to detect the syrup type.

A blender 304 optionally receives the carbonated mixture downstream the mixture sensor 212. If necessary, additional carbon dioxide from the carbon dioxide source 308 can be fed to the blender 304 with the gas pressure controller 306, as described above with respect to FIG. 6. Carbonated mixture flows from the blender 304 through the carbonated mixture conduit 310a.

The freezing stage 214 receives the carbonated mixture from the carbonated mixture conduit 310a and at least partially freezes the carbonated mixture. The prepared frozen carbonated beverage may be dispensed from the freezing stage 214 by opening a dispensing nozzle 314, which allows the beverage to flow out of the dispenser 104.

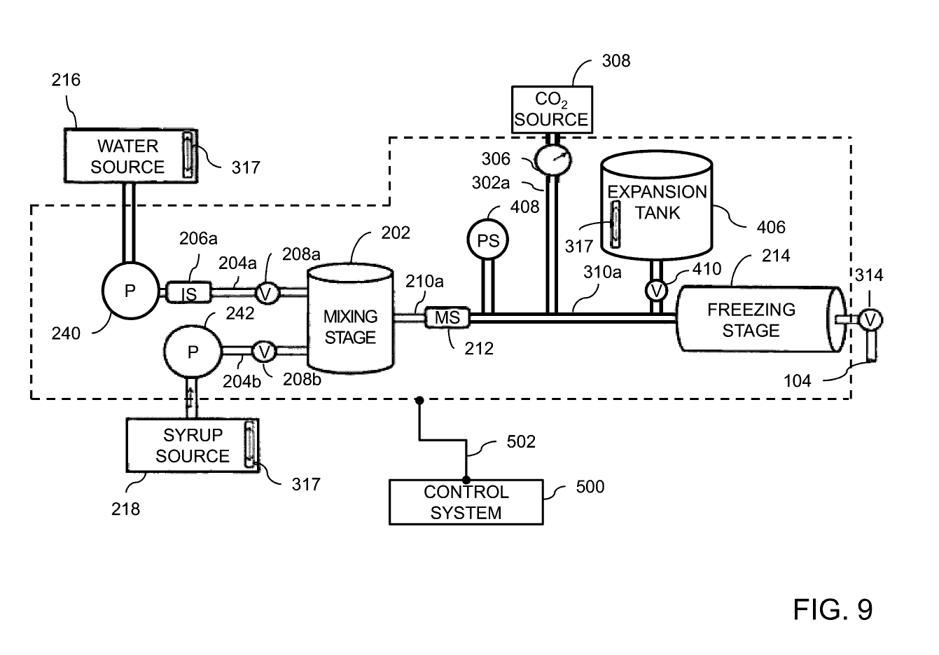

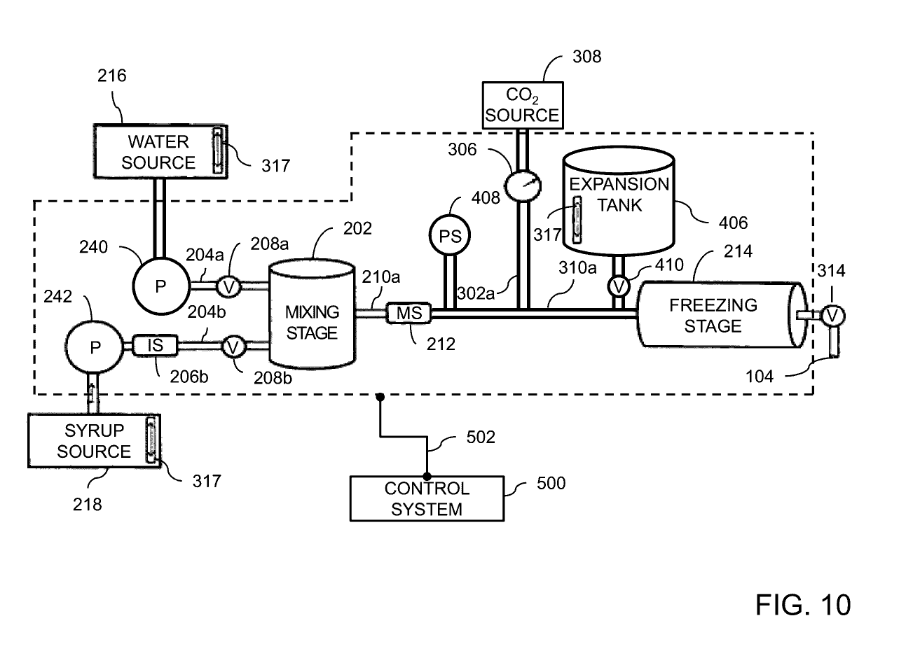

FIGS. 9 and 10 illustrate an embodiment with a combined brix control system 200 and carbonation control system 300 where carbonation occurs primarily in the freezing stage 214. With specific reference to FIG. 9, water is again provided to the apparatus 100 from a water source 216 and syrup is supplied from a syrup source 218. Water and syrup are drawn into, respectively, a water conduit 204a and a syrup conduit 204a by activating a water pump 240 and a syrup pump 242.

A liquid flow control device 208a, which can be in the form of a water flow valve, is positioned along the water conduit 204a for regulating water flow through the water conduit 204a. Upstream of the liquid flow control device 208a is at least one ingredient sensor 206a. The ingredient sensor 206a is a flowmeter that detects water flow through the water conduit 204a to the mixing stage 202. Another liquid flow control device 208b, which can be in the form of a syrup flow valve, is positioned along the syrup conduit 204b for regulating syrup flow through the syrup conduit 204b.

The valves 208a, 208b are incrementally adjustable so that the flow rate through each can be changed as needed. The flow rates may vary depending on the desired brix. Water and syrup are fed to the mixing stage 202 by the water and syrup conduits 204a, 204b at a flow rate that is determined by the water flow valve 208a and syrup flow valve 208b, respectively. The mixing stage 202 mixes the water and syrup to form the mixture. The mixture flows from the mixing stage 202 through the mixture conduit 210a, and mixture sensor 212 is positioned along the mixture conduit for detecting the flow of mixture therethrough.

A pressure sensor 408 is positioned downstream of the mixture sensor 212 and along the mixture conduit 210a. The pressure sensor 408 is adapted to control the fill of the mixture flowing from the mixing stage 202 to the freezing stage 214. Carbon dioxide is supplied to the carbon dioxide conduit 302a from a carbon dioxide source 308. The adjustable gas pressure controller 306, which can be in the form of an electronic carbon dioxide regulator, is positioned along the carbon dioxide conduit 302a for injecting carbon dioxide into the carbonated mixture conduit 310a. An expansion tank 406 can be provided upstream of the freezing stage 214 to prevent overfill in the freezing stage 214, such as when the pressure sensor 408 permits excess mixture from the mixing stage 202 or when carbon dioxide controller 306 provides excess carbon dioxide, for example. In this regard, the expansion tank 406 can include a valve 410 for diverting flow from the carbonated mixture conduit 310a and into the expansion tank. The expansion tank 406 can also include a liquid level sensor 317 for communicating liquid level values to the control system 500.

The freezing stage 214 receives the carbonated mixture from the carbonated mixture conduit 310a and at least partially freezes the carbonated mixture. The prepared frozen carbonated beverage may be dispensed from the freezing stage 214 by opening a dispensing nozzle 314, which allows the beverage to flow out of the dispenser 104.

The embodiment illustrated in FIG. 10 is substantially similar to the embodiment illustrated in FIG. 9, including the expansion tank 406 and pressure sensor 408. As shown in FIG. 10, at least one ingredient sensor 206b is included. The ingredient sensor 206b is a refractive sensor that detects sugar content of the syrup in the syrup conduit 204b. Downstream of the ingredient sensor 206b is the liquid flow control device 208b, which can be in the form of a syrup flow valve. The syrup valve 208b is positioned along the syrup conduit 204b for regulating syrup flow through the syrup conduit. Another liquid flow control device 208a, which can be in the form of a water flow valve, is positioned along the water conduit 204a for regulating water flow through the water conduit.

The water from water conduit 204a and the syrup from syrup conduit 204b are mixed at the mixing stage 202. The mixture flows from the mixing stage 202 through the mixture conduit 210a to the mixture sensor 212, which detects the sugar content of the mixture in mixture conduit 210a. Liquid flow is adjusted based on sugar content detected by the ingredient sensor 206b and mixture sensor 212 and by executing program instructions stored on the control system 500 for automatic operation of the liquid flow control devices 208a and 208b. The embodiment illustrated in FIG. 10 then operates in the same manner as discussed above with respect to FIG. 9.

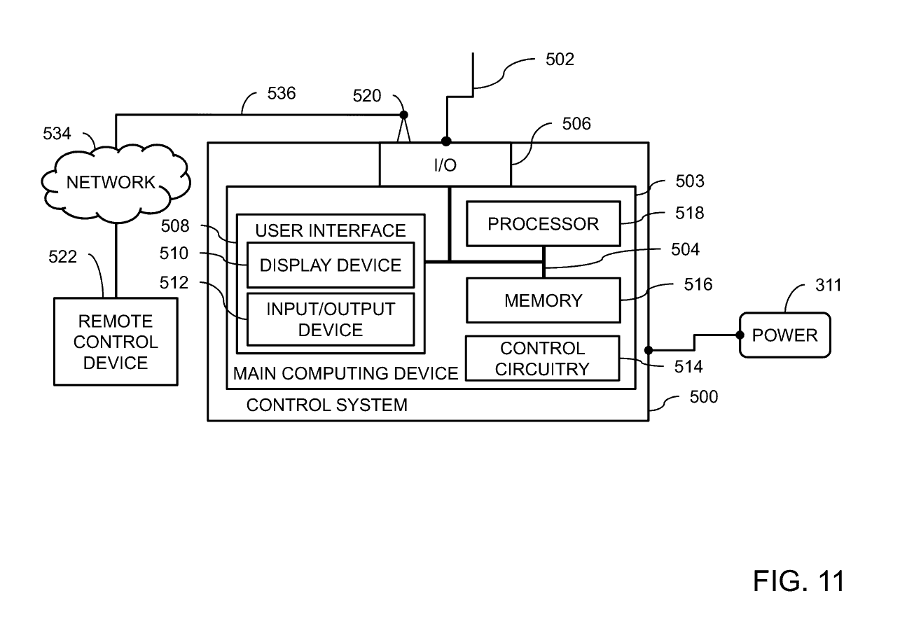

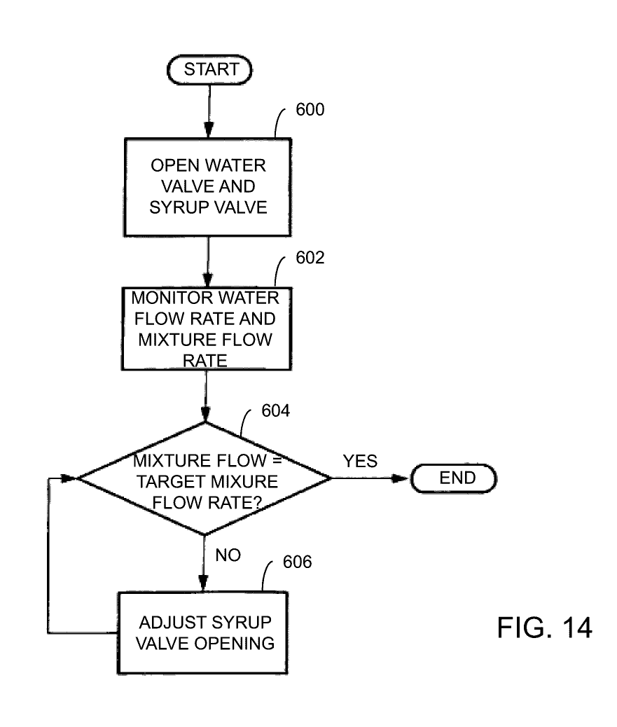

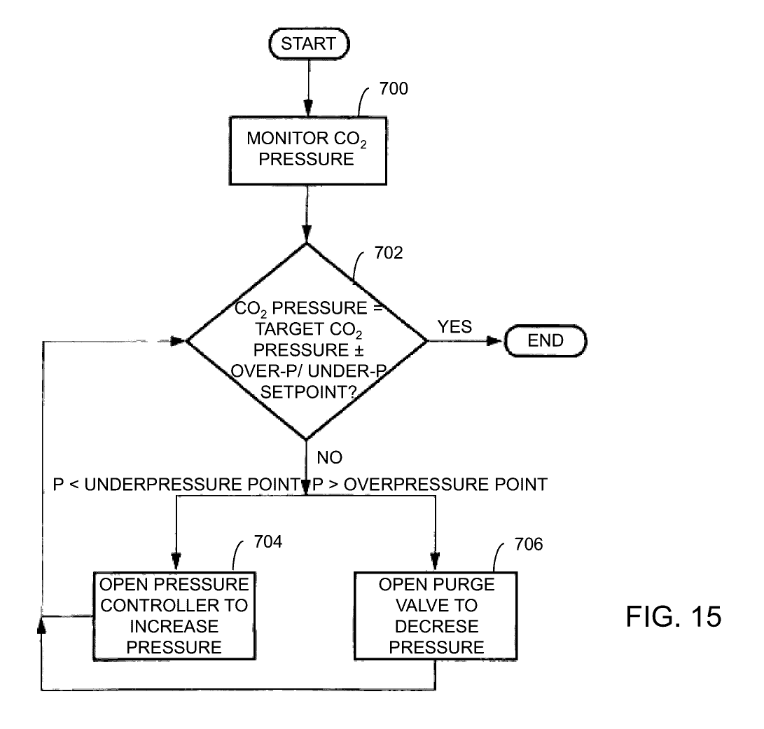

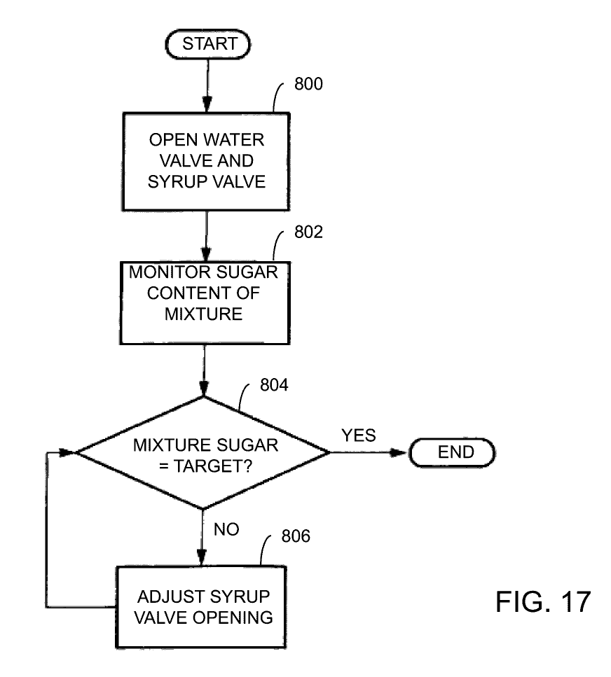

Additional details of the control system 500 will now be described with reference to FIGS. 11-17. Referring first to FIG. 11, the control system 500 generally includes a main computing device 503, a user interface 508, control circuitry 514, machine readable memory 516, and a processor 518. The processor 518 controls the overall operation of the computing device 503 by execution of processing instructions which are stored in a memory 516 connected to the processor 518 by a bus 504. The processor 518 also executes instructions, stored in memory 516, for performing the control functions of the control system 500. In other words, the processor 518 executes instructions to perform the exemplary methods outlined in FIG. 3, FIG. 5, FIG. 14, FIG. 15, and FIG. 17. A power supply 311 provides power to the control system 500 and the rest of the apparatus 100.

The control system 500 may include multiple processors 518, wherein each processor is allocated to processing particular (sets of) instructions. The control system 500 also includes one or more interfaces to connect the main computing device 503 to external devices, including an input output (I/O) interface 506. The I/O interface may communicate with a user interface 508 via bus 504. The user interface 508 may include one or more of a display device 510, for displaying information about the apparatus 100 to users, such as an LCD screen, and a user input device 512, such as a keyboard or touch or writable screen, and/or a cursor control device, such as a mouse, trackball, or the like, for inputting instructions and communicating user input information and command selections to the processor related to the apparatus.

The control circuitry 514 includes the electronic circuitry that allows the control system 500 to execute its functions. The control lines 502 discussed above are part of the control circuitry 514.

The control system 500 is may be part of the apparatus 100. It may be positioned inside the apparatus housing 102. In some embodiments, however, the control system 500 may remotely communicate with the rest of the apparatus 100 via a wireless communications device 520 that communicates via a network 534 such as the Internet. In some embodiments, the control system 500 may be remotely programmed and monitored from a remote control device 522 such as a PC, tablet, smart phone, other computing device that is connectable to the network 534. In this regard, the I/O 506 also links the computing device 503 with external devices, such as the illustrated remote control device 522, via wireless communications device 520. For example, I/O 506 may communicate with wireless communications device 520, which is in turn connected to a network 534, which links the main computing device 503 to remote control device 522 via wireless link 536.

The main computing device 503 may include a PC, such as a desktop, a laptop, palmtop computer, portable digital assistant (PDA), server computer, cellular telephone, pager, or other computing device or devices capable of executing instructions for performing the exemplary method or methods described herein.

The memory 516 may be separate or combined and may each represent any type of non-transitory computer readable medium, such as random access memory (RAM), read only memory (ROM), magnetic disk or tape, optical disk, flash memory, or holographic memory. In one embodiment, the memory 516 comprises a combination of random access memory and read only memory. In some embodiments, the processor 518 and memory 516 may be combined in a single chip.

The I/O interface 506 communicates with other devices via computer network 534, such as a local area network (LAN), a wide area network (WAN), or the Internet, and may comprise a modulator/demodulator (MODEM). The digital processor 518 can be variously embodied, such as by a single core processor, a dual core processor (or more generally by a multiple core processor), a digital processor and cooperating math coprocessor, a digital controller, or the like.

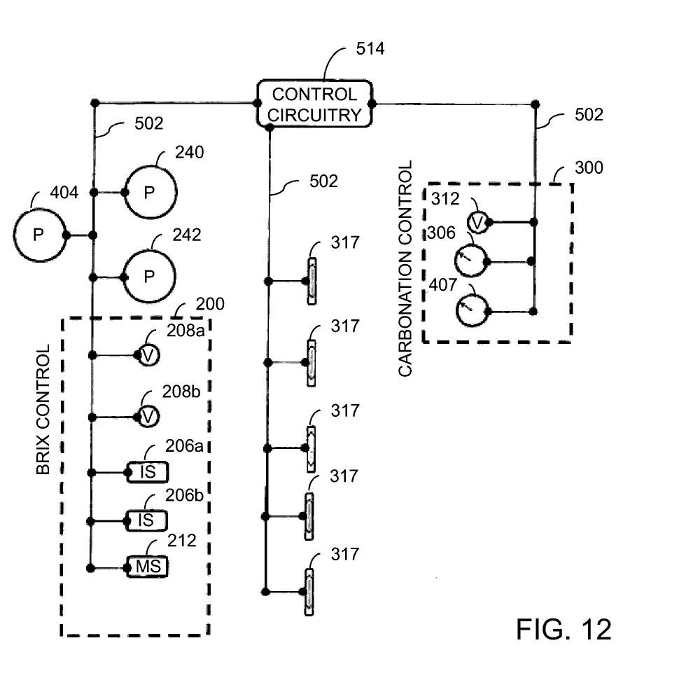

Details of some functions of the control system 500 will now be described with reference to FIG. 12, which shows an example schematic of the control circuitry 514 with control lines 502.

The control system 500 uses the control circuitry 514 to send commands and receive signals from various components of the apparatus 100. It Is noted that not all of the components and corresponding control circuitry illustrated in FIG. 12 may be required, depending on the desired layout of the brix and carbonation control systems described above.

The water pump 240 (or pump 404) and the syrup pump 242 are activated and deactivated by the control system 500 via the control circuitry 514.

Components of the brix control system 200 operational with the FCB systems of FIGS. 6-10 communicate with the control system 500 via the control circuitry 514 in order to adjust water flow through the water flow valve 208a, syrup flow through the syrup flow valve 208b, and receive the signals from the ingredient sensors 206 and mixture sensor 212.

Components of the carbonation control system 300 also communicate with the control system 500 via the control circuitry 514 in order to open and close the pressure relief valve 312, receive the signal from the pressure controller 306 associated with gas pressure at the blender 304 (FIGS. 6-8) or gas pressure upstream of the freezing stage (FIGS. 9 and 10), or the signal from the pressure controller 407 associated with gas pressure at the carbonator 402 (FIGS. 7 and 8), and send commands to the pressure controller 306, 407 to adjust the pressure.

The control system 500 can also receive liquid level values from liquid level sensors 317 in the water source 216, syrup source 218, blender 304, carbonator 402, and expansion tank 406. The liquid level sensors 317 may be conventional float switches that measure the amount of liquid in a container.

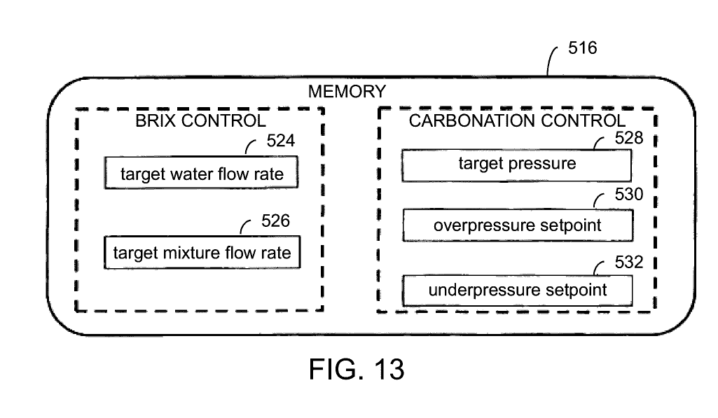

Referring to FIG. 13, the memory 516 stores input parameters that the brix control system 200 and carbonation control system 300 uses to achieve their target values.

For brix control, using the system of FIGS. 6, 7, and 9 as an example, the first ingredient sensor 206a is a flowmeter that detects the water flow rate or a value associated with the water flow rate and the mixture sensor 212 detects the mixture flow rate or a value associated with the mixture flow rate.

The target water flow rate 524 stored in the memory 516 is a predetermined value that is input by a user and corresponds to the water flow rate that will yield a mixture with the desired brix when the syrup flow rate is substantially constant.

The target mixture flow rate 526 is also input by a user and corresponds to the mixture flow rate that will yield the desired brix when then water flow rate is at the target water flow rate 524 and the syrup flow rate is substantially constant.

For carbonation control, the gas pressure controller 407 detects the gas pressure or a value associated with the gas pressure at the carbonator 402. Alternatively or additionally, the gas pressure controller 306 detects the gas pressure or a value associated with the gas pressure at the blender 304. The target pressure 528 is input by the user and is the pressure that will yield a frozen carbonated beverage with the desired carbonation level. The overpressure setpoint 530 and underpressure setpoint 532 effectively set the acceptable error in the pressure.

Referring to FIG. 14, the control system 500 uses the target water flow rate 524 and target mixture flow rate 526 to execute a brix control program summarized in the flow diagram. At block 600, the control system opens the water and syrup valves to allow water and syrup to flow through their respective conduits toward the mixing stage. The flow rate of the water remains substantially constant. At block 602, the control system monitors the water flow rate using the first ingredient sensor and the mixture flow rate using the mixture sensor. The control system then determines whether the mixture flow rate equals the target mixture flow rate (block 604). If not, the control system adjusts the syrup valve opening to either increase or decrease the syrup flow rate (block 606) until the target mixture flow rate is achieved.

Referring to FIG. 15, the control system 500 uses the pressure 528, overpressure setpoint 530, and underpressure setpoint 532 to execute a carbonation control program illustrated in the flowchart. At block 700, the control system monitors the carbon dioxide pressure using the gas pressure controller(s). The control system then determines whether the monitored carbon dioxide pressure equals the target pressure (block 702). If not, and the monitored pressure is less than the underpressure setpoint, the control system opens the pressure controller(s) to increase the pressure (block 704). On the other hand, if the monitored pressure is greater than the overpressure setpoint, the control system will open the pressure relief valve to decrease the pressure (block 706).

By way of example, the target pressure may be about 30 psi, the overpressure setpoint about 31 psi, and the underpressure setpoint about 29 psi. The target pressures, overpressure setpoint, and underpressure setpoints may vary depending on the equipment used and the desired carbonation level. In some markets, the carbonation level may be low, so the target pressure may be, for example, about 10 psi.

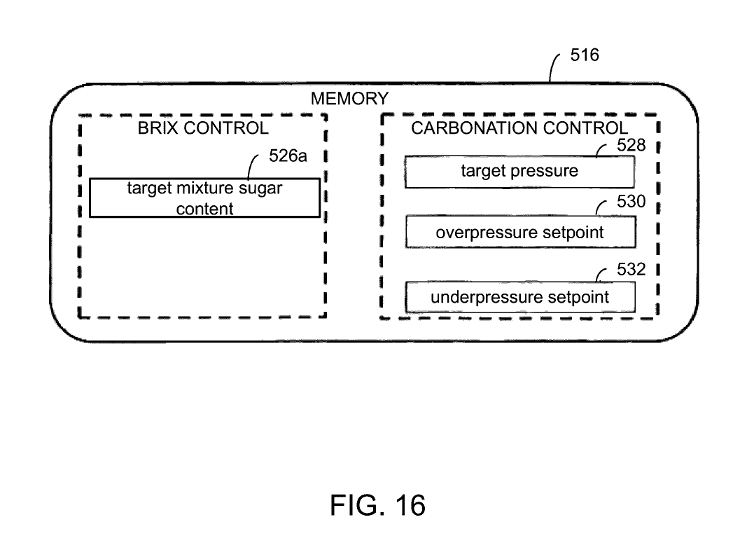

FIG. 16 illustrates another embodiment of the input parameters stored by memory 516 that the brix control system 200 and carbonation control system 300 uses to achieve their target values. For brix control in FIG. 16, using the system of FIGS. 8 and 10 as an example, the ingredient sensor 206b is a refractive sensor that detects the sugar content or a value associated with the sugar content and the mixture sensor 212 detects the mixture sugar content or a value associated with the mixture sugar content.

The target mixture sugar content 526a is input by a user and corresponds to the sugar content of the mixture that will yield the desired brix.

For carbonation control, the gas pressure controller 407 detects the gas pressure or a value associated with the gas pressure at the carbonator 402. Alternatively or additionally, the gas pressure controller 306 detects the gas pressure or a value associated with the gas pressure at the blender 304. The target pressure 528 is input by the user and is the pressure that will yield a frozen carbonated beverage with the desired carbonation level. The overpressure setpoint 530 and under pressure setpoint 532 effectively set the acceptable error in the pressure.

Referring to FIG. 17, the control system 500 uses the target mixture sugar content 526a to execute a brix control program summarized in the flow diagram. At block 800, the control system opens the water and syrup valves to allow water and syrup to flow through their respective conduits toward the mixing stage. The flow rate of the water and syrup remain substantially constant. At block 802, the control system monitors the sugar content of the mixture using the mixture refractive sensor. The control system then determines whether the sugar content of the mixture equals the target sugar content of the mixture (block 804). If not, the control system adjusts the syrup valve opening or water valve opening to either increase or decrease the syrup or water flow rate (block 806) until the target mixture sugar content is achieved. The memory 516 illustrated in FIG. 16 can execute the carbonation control program shown in the flowchart of FIG. 15 to monitor and adjust carbon dioxide pressure as discussed above.

The various components of the brix control systems and carbonation control systems described above, such as, for example, conduits 204a, 204b, 210a, 302a, 310a, 405a, freezing stage 214, blender 304, carbonator 402, and expansion tank 406 can be made from any suitable material known to those having skill in the art, such as stainless steel for example. Furthermore, the aforementioned components can all be joined together using any suitable attachment means. For example, the components can be joined using nickel (Ni) based filler metals, which are useful for brazing ferrous and nonferrous high temperature base metals. These nickel-based alloy metals are generally desired for their strength, temperature properties, and resistance to corrosion. One such suitable brazing material for joining the various components of the frozen carbonated beverage dispensing apparatus includes a nickel-boron (BNi) alloy, such as BNi-6.

Moisture is a common problem for frozen carbonated beverage dispensing apparatuses, where freezing and cause expansion and contraction of the various components due to the low temperatures at which these systems operate. This expansion can cause cracking in the components of the dispenser, which may lead to the development of leaks within the apparatus. Use of the aforementioned brazing materials advantageously increases the strength of the joints between the various components, which helps to prevent leaks, reduces operation costs, and increases the life of the frozen carbonated beverage dispensing apparatus.

### EXAMPLE

An example of an operational sequence for the FCB system aspect of FIG. 6 is now described. This example is provided for illustration purposes and does not limit the scope of aspects or embodiments of the present disclosure.

The CO₂ pressure is checked to achieve a target pressure of about 30 psi. If the pressure exceeds the overpressure set point of about 31 psi, the pressure relief valve is activated to relieve pressure and return to about 30 psi.

The blender level is then checked.

The water and syrup valves are then activated and the first and second flowmeters are monitored. The target water flow rate is about 3.2 oz./sec. The syrup valve is varied to achieve a mixture flow rate of about 0.7 oz./sec. The water flow is held constant while the syrup flow rate is adjusted to achieve the target mixture flow rate.

The blender is filled until the blender liquid level sensor indicates the blender is full. The CO₂ pressure is maintained at about 30 psi. When the blender liquid level sensor indicates that the liquid level in the blender is low, the blender is filled until the blender liquid flowmeter indicates the blender is full. The FCB system may be defrosted on an adjustable frequency from about every 2 hours to about every 24 hours.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A frozen carbonated beverage making system comprising:
an ingredient flow path that feeds water and syrup to a mixing stage that mixes the water and syrup to form a mixture, the ingredient flow path including (i) at least one ingredient sensor positioned along either a water or syrup flow path that detects a property of the water or syrup and (ii) at least one adjustable liquid flow control device that adjusts liquid flow through the ingredient flow path;
a mixture flow path that receives the mixture downstream the mixing stage, the mixture flow path including a mixture sensor that detects a property of the mixture;
at least one carbon dioxide flow path that feeds carbon dioxide to the frozen carbonated beverage making system, the at least one carbon dioxide flow path including an adjustable gas pressure controller that detects and regulates the carbon dioxide gas pressure of the system;
an electronic control system: (i) in connected communication with the at least one ingredient sensor, mixture sensor, at least one adjustable liquid flow control device, and the adjustable gas pressure controller; (ii) storing target values associated with a brix and a carbonation pressure and; (iii) configured to achieve the target values by adjusting liquid flow through the at least one liquid flow control device based on the property detected by the ingredient and mixture sensors and by adjusting carbonation pressure through the at least one adjustable gas pressure controller; and
a freezing stage downstream the mixing stage.

2. The system of claim 1, further comprising a carbonator upstream the mixing stage that receives and carbonates the water in the ingredient flow path from the at least one carbon dioxide flow path.

3. The system of claim 2, further comprising a blender upstream the freezing stage that receives and carbonates the mixture in the mixture flow path from the at least one carbon dioxide flow path.

4. The system of claim 3, wherein the blender carbonates the mixture from a second carbon dioxide flow path including an adjustable gas pressure controller that detects and regulates the carbon dioxide gas pressure of the blender.

5. The system of claim 3, wherein the at least one ingredient sensor is a flowmeter that detects and measures a flow rate of the water or syrup.

6. The system of claim 5, wherein the mixture sensor is a flowmeter that detects and measures a flow rate of the mixture.

7. The system of claim 6, wherein the electronic control system achieves the target value associated with the brix based on the flow rates detected by the at least ingredient sensor and the mixture sensor.

8. The system of claim 3, wherein the at least one ingredient sensor is a refractive sensor that detects and measures a sugar content of the syrup.

9. The system of claim 8, wherein the mixture sensor is a refractive sensor that detects and measures a sugar content of the mixture.

10. The system of claim 9, wherein the electronic control system achieves the target value associated with the brix based on the sugar content detected by the mixture sensor.

11. The system of claim 1, wherein the at least one carbon dioxide flow path feeds carbon dioxide to the freezing stage downstream the mixing stage.

12. The system of claim 11, wherein the at least one ingredient sensor and the mixture sensor are flowmeters that detect and measure flow rates of the water or syrup and the mixture.

13. The frozen beverage making system of claim 11, wherein the at least one ingredient sensor and the mixture sensor are refractive sensors that detect and measure a sugar content of the syrup and the mixture.

14. A method for making a frozen beverage comprising:
(a) receiving a first signal from an ingredient sensor positioned along either a water or syrup conduit of an ingredient flow path that feeds water and syrup to a mixing stage where the water and syrup are mixed;
(b) receiving a second signal from a mixture sensor positioned along a mixture flow path that receives the mixture from the mixing stage, the first and second signal being associated with a brix;
(c) receiving a signal from a gas pressure controller positioned along a carbon dioxide flow path that feeds carbon dioxide to the ingredient flow path or the mixture flow path, the signal being associated with gas pressure at the ingredient flow path or the mixture flow path;
(d) adjusting liquid flow through a liquid flow control device positioned along either the water or syrup flow path until a target value associated with the brix is achieved;
(e) adjusting the gas pressure with the gas pressure controller until a target value associated with a desired carbonating pressure is achieved; and
(f) at least partially freezing the mixture downstream the mixture flow path.

15. The method of claim 14, further comprising injecting carbon dioxide from the carbon dioxide flow path upstream the mixing stage at the water conduit of the ingredient flow path, downstream the mixing stage at the mixture flow path, or both.

16. The method of claim 15, further comprising monitoring a sugar content of the mixture with the mixture sensor to generate the second signal and wherein the target value associated with the brix is a target sugar content of the mixture.

17. The method of claim 15, further comprising monitoring a flow rate in either the water or syrup conduit with the ingredient sensor to generate the first signal and monitoring a flow rate in the mixture flow path with the mixture sensor to generate the second signal, wherein the target value associated with the brix is a target water or syrup flow rate and a target mixture flow rate.

18. A frozen beverage making apparatus comprising:
a water conduit and a syrup conduit that feed water and syrup to a mixing stage that forms a mixture, the water conduit having a water flow valve for regulating water flow through the water conduit and the syrup conduit having a syrup flow valve for regulating syrup flow though the syrup conduit;
a carbon dioxide conduit having a gas pressure controller for feeding carbon dioxide to the frozen beverage making apparatus, the gas pressure controller including a pressure sensor for regulating carbonation pressure in the system;
an ingredient sensor positioned along at least one of the water conduit and the syrup conduit for measuring a property of the water or syrup;
a mixture conduit that receives the mixture and includes a mixture sensor for measuring a property of the mixture;
at least one of: (i) a carbonator that receives and carbonates the water in the water conduit from the carbon dioxide conduit and (ii) a blender that receives and carbonates the mixture in the mixture conduit from the carbon dioxide conduit;
an electronic control system: (i) in connected communication with the ingredient sensor, the water flow valve, the syrup flow valve, and the gas pressure controller; (ii) storing target values associated with a brix and the carbonation pressure and; (iii) configured to achieve the target values by adjusting at least one of water flow through the water flow valve and syrup flow through the syrup flow valve, based on the property detected by the ingredient and mixture sensors, and by adjusting carbonation pressure through the gas pressure controller; and
a freezing stage that receives and at least partially freezes the mixture.

19. The frozen beverage making apparatus of claim 18, wherein the ingredient sensor and the mixture sensor is a flowmeter that detects and measures a flow rate of the water or syrup and the flow rate of the mixture.

20. The frozen beverage making apparatus of claim 18, wherein the ingredient sensor and the mixture sensor is a refractive sensor that detects and measures sugar content of the syrup and sugar content of the mixture.
